(19) United States
(12) Patent Application Publication
(10) Pub. No.: US 2009/0286127 A1
(43) Pub. Date: Nov. 19, 2009

(54) Cell unit for a fuel cell and method for manufacturing the same

(75) Inventors: Nathan E. Stott, Suwon-si (KR); Jae-Woo Joung, Suwon-si (KR); Jae-Hyuk Jang, Seoul (KR); Craig Miesse, Seoul (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 12/379,120

(22) Filed: Feb. 12, 2009

(30) Foreign Application Priority Data
May 19, 2008 (KR) 10-2008-0045936
Dec. 9, 2008 (KR) 10-2008-0124802

(51) Int. Cl. H01M 8/10; B32B 37/00

(52) U.S. Cl. 429/32; 429/30; 156/277

(57) ABSTRACT

Disclosed are a cell unit for a fuel cell and a method for manufacturing the same. The cell unit for a fuel cell can include an electrolyte membrane; an electrode unit, comprising an anode being formed on one surface of the electrolyte membrane and a cathode being formed on the other surface of the electrolyte membrane; a current collector, being stacked on the electrode unit to be electrically connected to the electrode unit; and a conductive layer, being interposed between the electrode unit and the current collector to reduce a contact resistance between the electrode unit and the current collector. With the present invention, the cell unit for a fuel cell can reduce contact resistance between the anode and the cathode and the current collector. Accordingly, it can be possible to reduce the overall size of the fuel cell by reducing the required thickness of the end plate.

### CROSS-REFERENCE TO RELATED APPLICATIONS

This application claims the benefit of Korean Patent Application No. 10-2008-0045936 and No. 10-2008-0124802 filed with the Korean Intellectual Property Office on May 19, 2008, and Dec. 9, 2008, respectively, the disclosure of which is incorporated herein by reference in its entirety.

### BACKGROUND

1. Technical Field

The present invention relates to a cell unit for a fuel cell and a method for manufacturing the cell unit for a fuel cell.

2. Description of the Related Art

Today, portable electronic apparatuses are being provided in smaller sizes and with a greater variety of functions, and accordingly, there has been a demand for higher efficiency and longer operation times in devices for supplying electrical power to such portable electronic apparatuses. In this context, the cell unit for a fuel cell, which converts chemical energy directly into electrical energy, is gaining importance as a new alternative for radically increasing the efficiency and durability of a portable power supply.

According to the related art, current collectors are juxtaposed against the anode and cathode of a membrane electrode assembly. This juxtaposition, however, introduces contact resistance between the current collectors and their respective electrodes. Accordingly, it is required to uniformly apply high compression to reduce the contact resistance. This generally requires the use of thick endplates and results in the increase of the overall size of a fuel cell.

### SUMMARY

The present invention provides a cell unit for a fuel cell and a method for manufacturing the same that reduce contact resistance between an anode and a cathode and a current collector, to thereby reduce the overall size of a fuel cell.

An aspect of the invention features a cell unit for a fuel cell including an electrolyte membrane; an electrode unit, comprising an anode being formed on one surface of the electrolyte membrane and a cathode being formed on the other surface of the electrolyte membrane; current collectors, being stacked on the electrode unit to be electrically connected to the electrode unit; and a conductive layer, being interposed between the electrode unit and the current collectors to reduce a contact resistance between the electrode unit and the current collectors.

A plurality of electrode units can be included, and the current collector can be a flexible printed circuit board which electrically connects the plurality of electrode units to each other.

The current collector can electrically connect the plurality of electrode units to each other in series.

Another aspect of the invention features a method for manufacturing a cell unit for a fuel cell, in which a current collector is stacked on an electrode unit having an anode and a cathode, the method including forming the electrode unit on both surfaces of an electrolyte membrane; forming a conductive layer on the electrode unit to reduce a contact resistance between the electrode unit and the current collector; and stacking the current collector on the conductive layer to be electrically connected to the electrode unit.

The conductive layer can be performed by applying a conductive material on the electrode unit by use of an inkjet method.

The method can further include curing and sintering the conductive layer, after the stacking the current collector

The method can further include pressing the current collector, after the stacking the current collector.

The curing and sintering the conductive layer and the pressing the current collector can be simultaneously performed.

A plurality of electrode units can be included, and the current collector can be a flexible printed circuit board which electrically connects the plurality of electrode units to each other.

The current collector can electrically connect the plurality of electrode units to each other in series.

### BRIEF DESCRIPTION OF THE DRAWINGS

FIG. 1 is a plan view showing a cell unit for a fuel cell in accordance with an embodiment of the present invention;

FIG. 2 is a side view showing a cell unit for a fuel cell in accordance with an embodiment of the present invention;

FIG. 3 is a partially enlarged view showing a part “A” of FIG. 2;

FIG. 4 is a flowchart showing a method of manufacturing a cell unit for a fuel cell in accordance with an embodiment of the invention;

FIG. 5 through FIG. 7 briefly show each process of a method of manufacturing a cell unit for a fuel cell in accordance with an embodiment of the invention;

FIG. 8 through FIG. 10 are plan views showing each process of a method of manufacturing a cell unit for a fuel cell in accordance with an embodiment of the invention; and

FIG. 11 through FIG. 13 are side views showing each process of a method of manufacturing a cell unit for a fuel cell in accordance with an embodiment of the invention.

### DETAIL DESCRIPTION

A cell unit for a fuel cell and a method for manufacturing the same according to certain embodiments of the invention will be described below in detail with reference to the accompanying drawings. Those elements that are the same or are in correspondence are rendered the same reference numeral regardless of the figure number, and redundant explanations can be omitted.

When one element is described as being “stacked” on another element, it shall be construed not only as being stacked on another element directly but also as possibly having yet another element in between.

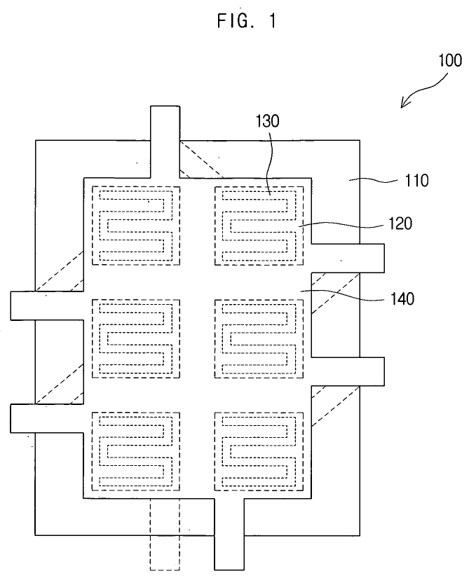

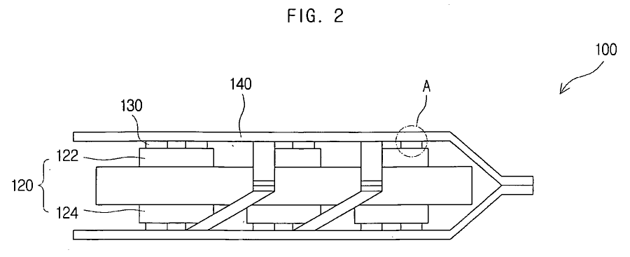

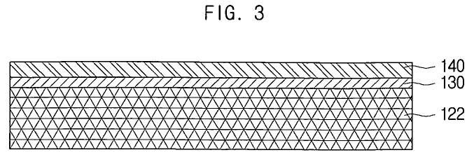

FIG. 1 is a plan view showing a cell unit for a fuel cell in accordance with an embodiment of the present invention, and FIG. 2 is a side view showing a cell unit for a fuel cell in accordance with an embodiment of the present invention. FIG. 3 is a partially enlarged view showing a part “A” of FIG. 2.

In FIG. 1 through FIG. 3, there are shown a cell unit 100 for a fuel cell, an electrolyte membrane 110, an electrode unit 120, an anode 122, a cathode 124, a conductive layer 130, and a current collector 140.

In accordance with an embodiment of the present invention, the cell unit 100 for a fuel cell can reduce contact resistance between the anode 122 and the cathode 124 and the current collector 140 by interposing the conductive layer 130 between the electrode unit 120 and the current collector 140, and thereby make the thickness of an end plate thinner. Accordingly, the present invention suggests the cell unit 100 for a fuel cell that can miniaturize the fuel cell.

The cell unit 100 for a fuel cell can also reduce its overall thickness as compared with a bipolar stack structure by forming a plurality of electrode units 120 and by electrically connecting the electrode units 120 to each other by the current collector 140 and can increase generated electrical energy by connecting the plurality of electrode units 120 in series, thereby being adequate for apparatuses requiring higher voltage apparatuses.

The electrolyte membrane 110 can be interposed between the anode 122 and the cathode 124 and move hydrogen ions generated by an oxidation reaction at the anode 122 to the cathode 124. It can be also possible to use a polymer material.

The electrode unit 120 can be formed to include the anode 122 and the cathode 124, and a plurality of electrode units 120 can be formed on a surface of the electrolyte membrane 110. The anode 122 can be formed on one surface of the electrolyte membrane 110 and be supplied with a fuel such as hydrogen, and then can undergo an oxidation reaction at a catalyst layer of the anode 122 to generate hydrogen ions and electrons. The cathode 124 can be formed on the other surface of the electrolyte membrane 110 and be supplied with oxygen and the electrons generated at the anode 122, and then can undergo a reduction reaction at the catalyst layer of the cathodes 124 to generate oxygen ions.

Such oxidation and reduction reactions can be utilized to obtain electrical energy directly from chemical energy. The chemical reactions at the anodes 122 and cathodes 124 can be represented by the following Reaction Scheme 1.

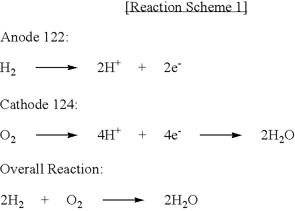

Since a plurality of electrode units 120 can be formed on both surfaces of the electrolyte membrane 110, electrically connecting the electrode units 120 in series can provide a higher voltage without increasing the overall thickness unlike a bipolar stack structure. This will be described below in the following description related to the current collector 140.

The current collector 140 can be stacked on the electrode unit 120 to be electrically connected to the electrode unit 120. In particular, as described above, the electrons can be generated by the oxidation reaction caused at a catalyst layer of an anode 122. These electrons can be collected at the current collector 140 through a gas diffusion layer of the anode 122. Then, the electrons can be collected at the anode 122 side of the current collector 140. The collected electrons can move to a gas diffusion layer and a catalyst layer of a cathode 124 through the cathode 124 side of the current collector 140, which is connected to the anode 122 side of the current collector 140, to thereby cause the reduction reaction. Depending on the configuration of the anode 122 and the cathode 124, the electrons may pass through an external lead or circuit when passing from an anode 122 side of current collector 140 to a cathode 124 side of current collector 140.

In this case, interposing the conductive layer 130 between the current collector 140 and the electrode unit 120 can make it possible to reduce contact resistance between the current collector 140 and the electrode unit 120, thereby to improve current collection efficiency and electrical conductivity. This will be described below in the following description related to the conductive layer 130.

The current collector 140 can be a flexible printed circuit board making an electrical connection between the plurality of electrode units 120. In particular, the current collector 140 can not only collect the electrons but also electrically connect the electrode units 120 which are arranged on the same planar surface, thereby reducing the overall thickness of the cell unit 100 for a fuel cell in order to manufacture the compacted cell unit 100 for a fuel cell.

Using the flexible printed circuit board as the current collector 140 can also make it possible to make more stable sealing between the anode 122 and cathode 124 than using the related art punching the electrolyte membrane 110 to electronically each of the electrode unit 120, thereby manufacturing the cell unit 100 for a fuel cell more stable and efficiently.

The current collector 140 can electrically connect an anode 122 of one electrode unit 120 to a cathode of another electrode unit 120 in order to electrically connect the plurality of electrode units 120 to each other in series. In other words, the electrode units 120 can be arranged in a latticed form on both surfaces of the electrolyte membrane 110, and the plurality of electrode units 120 can be electrically connected in series by electrically connecting an anode 122 of one electrode unit 120 to a cathode 124 of another electrode unit 120, through the current collector 140.

The current collector 140 can be electrically connected to an external device or circuit.

Since the plurality of electrode units 120 are electrically connected to each other by using the current collector 140, it can be possible to increase the voltage of generated electrical energy and accordingly, to become adequate for an apparatus requiring higher voltage. In this case, increasing the voltage can cause no change of thickness. This can control a voltage without any restriction of the thickness.

The conductive layer 130 can be interposed between the electrode unit 120 and the current collector 140 to reduce contact resistance between the current collector 140 and the electrode unit 120. As described above, when the electrons generated by the oxidation reaction of the catalyst layer of an anode 122 are collected at the anode 122 side of the current collector 140 through the gas diffusion layer of the anode 122, and then, either directly or via an external lead or circuit, move to a cathode 124 through the cathode 124 side of the current collector 140, to thereby cause the reduction reaction, the conductive layer 130 formed by using an inkjet method can be interposed between the current collector 140 and the gas diffusion layer of the anode 122 and the cathode 124 in order to increase the compression force there between. This can make it possible to enhance the efficiency of the cell unit 100 for a fuel cell by reducing the contact resistance and by improving the electrical conductivity.

With such increase in current collection efficiency caused by using the conductive layer 130, it can be possible to make thinner the thickness of the end plate used for the fuel cell, to thereby reduce the size of the fuel cell.

If the current collector 140 is a flexible printed circuit board, which is not shown in any drawings, an area in which no circuit pattern is formed in the flexible printed circuit board can be punched to supply reactants to the electrode unit (120). Since the conductive layer 130 is formed corresponding to a circuit pattern of the flexible printed circuit board, some parts of the anode 122 and the cathode 124 are open. Accordingly, fuel such as hydrogen or oxygen can be more easily supplied through the opened parts of the anode 122 and the cathode 124.

The conductive layer 130 can be formed by applying a conductive material on the electrode unit 120 in the inkjet method. Then, the current collector 140 can be stacked on the conductive layer 130. Thereafter, the cell unit 100 for a fuel cell with its greatly reduced contact resistance can be manufactured by pressing the current collector 140 and simultaneously by curing and sintering the conductive layer 130.

By applying a conductive material, for example, having gold particles of 100 nanometers or smaller to the electrode unit 120, it can be possible to coat the conductive material on the electrode unit 120 Then, the conductive material can be cured and sintered, for example, at a temperature of 100 through 1000 degrees Celsius in order to form the conductive layer 130 having a plurality of micro pores corresponding to the pores of the electrode unit 120.

At this time, The gold particles within the conductive material can then bond with one another as a kind of an adhesive. This can cause the conductive layer 130 to be closely in contact with the current collector 140 and the electrode unit 120, respectively, to thereby reduce the contact resistance between the current collector 140 and the electrode unit 120 efficiently.

On the other hand, it may be required to adjust the hydrophile-lipophile balance (HLB) between the conductive material and the electrode unit 120 in order to prevent the damage of the catalyst layer or the electrolyte membrane 110, caused by the seepage of the conductive material into the electrode unit 120. It can be possible to adjust the HLB by changing the property of ink made of a conductive material or process the surface of the electrode unit 120 in order to adjust a wetting property of the conductive material to be adequate for the electrode unit 120.

As such, since forming the conductive layer 130 by using the inkjet method causes the current collector 140, the conductive layer 130, and the electrode unit 120 to be closely in contact with each other, it can be possible to reduce the contact resistance between the current collector 140 and the anode 122 and the cathode 124. Accordingly, it can be possible to reduce the overall size of the fuel cell by reducing the required thickness of the end plate.

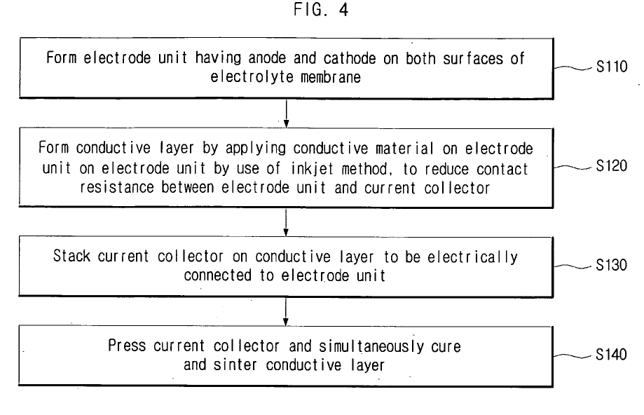

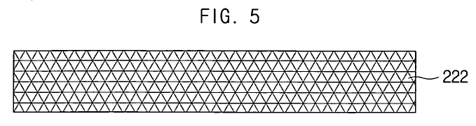

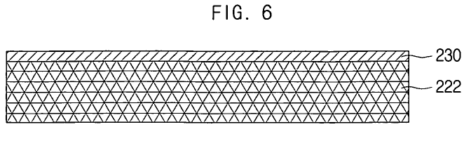

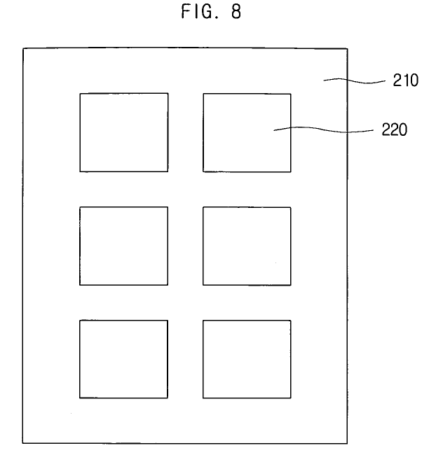

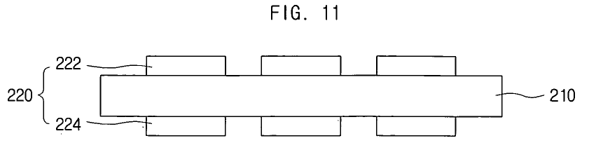

FIG. 4 is a flowchart showing a method of manufacturing a cell unit for a fuel cell in accordance with an embodiment of the invention, and FIG. 5 through FIG. 7 briefly show each process of a method of manufacturing a cell unit for a fuel cell in accordance with an embodiment of the invention. FIG. 8 through FIG. 10 are plan views showing each process of a method of manufacturing a cell unit for a fuel cell in accordance with an embodiment of the invention, and FIG. 11 through FIG. 13 are side views showing each process of a method of manufacturing a cell unit for a fuel cell in accordance with an embodiment of the invention.

In FIG. 5 through FIG. 13, there are shown a cell unit 200 for a fuel cell, an electrolyte membrane 210, an electrode unit 220, an anode 222, a cathode 224, a conductive layer 230, a current collector 240, and an inkjet head 250.

Below shown is the cell unit 200 for a fuel cell in accordance with an embodiment of the present invention that can reduce contact resistance between an electrode, either anode 222 or the cathode 224, and its corresponding current collector 240 by forming the conductive layer 230 on the electrode unit 220 by use of an inkjet method. Accordingly, the present invention suggests a method for manufacturing a fuel cell that can miniaturize a fuel cell by reducing the required thickness of an end plate.

Moreover, below shown is a method for manufacturing the cell unit 200 for a fuel cell that can reduce its overall thickness as compared with a bipolar stack structure by forming a plurality of electrode units 220 and by electrically connecting the electrode units 220 to each other by the current collector 240 and can increase generated electrical energy by connecting the plurality of electrode units 220 in series, thereby being adequate for an apparatus requiring higher voltage.

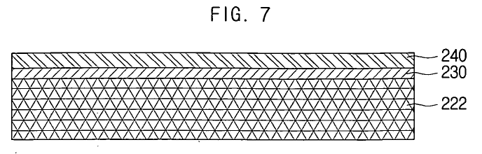

As shown in FIG. 5 though FIG. 7, the method for manufacturing the cell unit 200 for a fuel cell 200 in accordance with an embodiment of the present invention can include processes of forming the conductive layer 230 on the electrode unit 200 having the anode 222 and the cathode 220, stacking the current collector 240 on the conductive layer 230, pressing the current collector 240, and curing and sintering the conductive layer 230. Hereinafter, each process will be described in detail.

As shown in FIG. 8 and FIG. 11, the electrode unit 220 can be formed on both surfaces of the electrolyte membrane 210 in a process represented by S110.

Here, the electrolyte membrane 210 can be interposed between the anode 222 and the cathode 224 and transmit hydrogen ions generated by an oxidation reaction at the anode 222 to the cathode 224. It can be also possible to use a polymer material.

The electrode unit 220 can be formed to include the anode 222 and the cathode 224, and a plurality of electrode units 220 can be formed on a surface of the electrolyte membrane 210. The anode 222 can be formed on one surface of the electrolyte membrane 210 and be supplied with a fuel such as hydrogen, and then can undergo an oxidation reaction at a catalyst layer of the anode 222 to generate hydrogen ions and electrons. The cathode 224 can be formed on the other surface of the electrolyte membrane 210 and be supplied with oxygen and the electrons generated at an anode 222, and then can undergo a reduction reaction at the catalyst layer of the cathodes 224 to generate oxygen ions.

Such oxidation and reduction reactions can be utilized to obtain electrical energy directly from chemical energy. The chemical reactions at the anodes 222 and cathodes 224 can be represented by the aforementioned Reaction Scheme 1.

Since a plurality of electrode units 220 can be formed on both surfaces of the electrolyte membrane 210, electrically connecting the electrode units 220 in series can provide a higher voltage without increasing the overall thickness unlike a stack structure. This has been described through the aforementioned embodiment of the present invention.

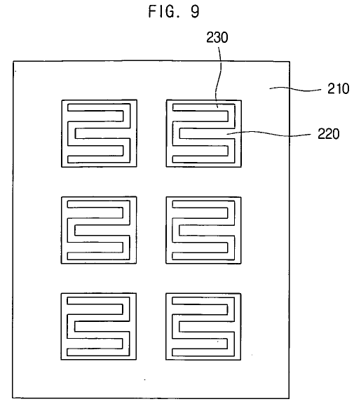

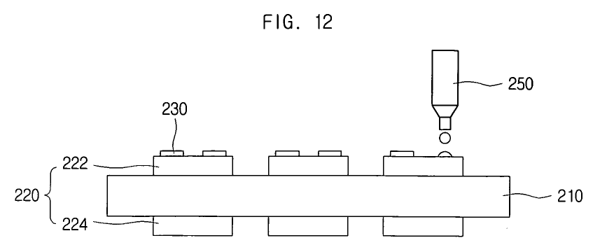

Then, as shown in FIG. 9 and FIG. 12, the conductive layer 230 can be formed by applying a conductive material on the electrode unit 220 by use of an inkjet method, to reduce contact resistance between the electrode unit 220 and the current collector 240 in a process represented by S120.

By applying a conductive material, for example, having gold particles of 100 nanometers or smaller to the electrode unit 220, it can be possible to coat the conductive material onto the electrode unit 220 Then, the current collector 240 can be stacked on the conductive layer 230 and the conductive material can be cured and sintered, for example, at a temperature of 100 through 1000 degrees Celsius in order to form the conductive layer 230 having a plurality of micro pores corresponding to the pores of the electrode unit 220.

At this time, The gold particles within the conductive material can then bond with one another as a kind of an adhesive. This can cause the conductive layer 230 to be closely in contact with the current collector 240 and the electrode unit 220, respectively, to thereby reduce the contact resistance between the current collector 240 and the electrode unit 220 efficiently.

On the other hand, it may be required to adjust the hydrophile-lipophile balance (HLB) between the conductive material and the electrode unit 220 in order to prevent the damage of the catalyst layer or the electrolyte membrane 210, caused by the seepage of the conductive material into the electrode unit 220. It can be possible to adjust the HLB by changing the property of ink made of a conductive material or process the surface of the electrode unit 220 in order to adjust a wetting property of the conductive material to be adequate for the electrode unit 220.

As such, since forming the conductive layer 230 by using the inkjet method causes the current collector layer 240, the conductive layer 230 and the electrode unit 220 to be closely in contact with each other, it can be possible to reduce the contact resistance between the electrodes, anode 222 and/or cathode 224, and their corresponding current collector layers 240. Accordingly, it can be possible to reduce the overall size of the fuel cell by reducing the required thickness of the endplate.

In other words, when the electrons generated by the oxidation reaction of the catalyst layer of an anode 222 are collected at the anode 222 side of the current collector 240 through a gas diffusion layer of an anode 222, and then, either directly or via an external lead or circuit, move to a cathode 224 through the cathode 224 side of the current collector 240, thereby causing the reduction reaction, the conductive layer 230 can be interposed between the current collector 240 and the gas diffusion layer of the anode 222 and the cathode 224 in order to increase the compression force therebetween. This can make it possible to enhance the efficiency of the cell unit 200 for a fuel cell by reducing the contact resistance between the electrode unit 220 and current collectors 240.

If the current collector 240 is a flexible printed circuit board, an area in which no circuit pattern is formed in the flexible printed circuit board can be punched to supply a fuel. Since the conductive layer 230 is formed corresponding to a circuit pattern of the flexible printed circuit board, some parts of the anode 222 and the cathode 224 are open. Accordingly, the fuel such as hydrogen or oxygen can be more easily supplied through the opened parts of the anode 222 and the cathode 224

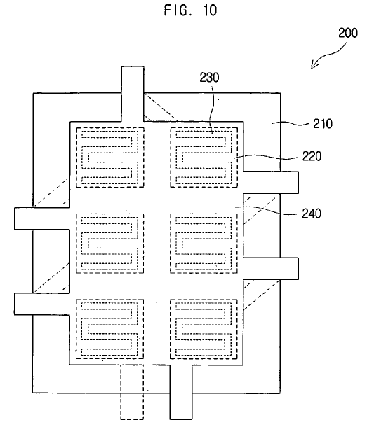

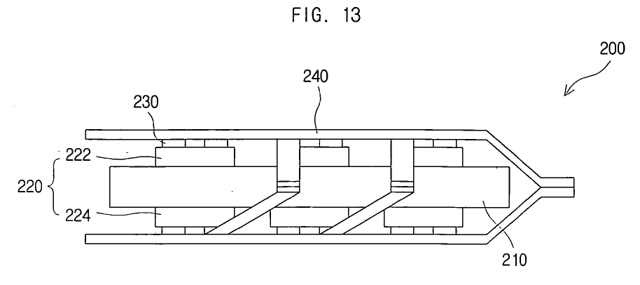

Then, as shown in FIG. 10 and FIG. 13, the current collector 240 can be stacked on the conductive layer 230 to be electrically connected to the electrode unit 220 in a process represented by S130.

In particular, the conductive layer 230 can be formed on the electrode unit 220 by using an inkjet method, and then the contact resistance between the current collector 240 and the electrode unit 220 can be reduced by pressing the current collector 240 and simultaneously by curing and sintering the conductive layer 230.

The current collector 240 can be a flexible printed circuit board making an electrical connection between a plurality of electrode units 220. In particular, the current collector 240 can not only collect the electrons but also electrically connect the electrode units 220 which are arranged on the same planar surface, thereby reducing the overall thickness of the cell unit 200 for a fuel cell in order to manufacture the compacted cell unit 200 for a fuel cell.

Using the flexible printed circuit board as the current collector 240 can also make it possible to make more stable sealing between the anode 222 and cathode 224 than using the related art punching the electrolyte membrane 210 to electronically each electrode unit 220, thereby manufacturing the cell unit 200 for a fuel cell more stable and efficiently.

The current collector 240 can electrically connect an anode 222 of one electrode unit 220 to a cathode of another electrode unit 220 in order to electrically connect the plurality of electrode units 220 to each other in series. In other words, the electrode units 220 can be arranged in a latticed form on both surfaces of the electrolyte membrane 210, and the plurality of electrode units 220 can be electrically connected in series by electrically connecting an anode 222 of one electrode unit 220 to a cathode of another electrode unit 220 through the current collector 240.

Since using the current collector 240 electrically connects the plurality of electrode units 220 to each other, it can be possible to increase the voltage of generated electrical energy and accordingly, to become adequate for apparatuses requiring higher voltage. In this case, increasing the voltage can cause no change of thickness. This can control voltage without any restriction of the thickness.

Finally, the current collector 240 can be pressed, and simultaneously the conductive layer 230 can be cured and sintered in a process represented by S140.

In particular, if the current collector 240 can be pressed, and the conductive layer 230 is simultaneously cured and sintered, for example, at a temperature of 100 through 1000 degrees Celsius as described above, the gold particles within the conductive material can then bond with one another forming a connected body. This can cause the conductive layer 230 to become in more intimate electrical contact with the current collector 240 and the electrode unit 220, respectively. As a result, it can be possible to manufacture the cell unit 200 for a fuel cell that can efficiently reduce the contact resistance between the electrode unit 220 and their corresponding current collectors 240.

On the other hand, in accordance with the method for manufacturing the cell unit 200 for a fuel cell according to an embodiment of the present invention, the process represented by S110 in which the electrode unit 220 is formed on the electrolyte membrane 210 can be firstly performed, and then the process represented by S120 in which the conductive layer 230 is formed on the electrode unit 220 can be performed. The process represented by S130 in which the current collector 240 is stacked on the conductive layer 230 and the process represented by S140 in which the conductive layer 230 is cured and sintered can be performed. The method for manufacturing the cell unit 200 for a fuel cell, however, can be performed in another order. For example, after the conductive layer 230 and the current collector 240 are formed on the electrode unit 220 through the processes represented by S120, S130, and S140, the process represented by S110 in which the electrode unit 220 is formed on the electrolyte membrane 210 can be performed. This reflects that the order of the processes is changed but the details of each process is not changed, and thus the detailed pertinent description is omitted.

Many embodiments other than those set forth above can be found in the appended claims.

While the spirit of the invention has been described in detail with reference to particular embodiments, the embodiments are for illustrative purposes only and do not limit the invention. It is to be appreciated that those skilled in the art can change or modify the embodiments without departing from the scope and spirit of the invention.

What is claimed is:

1. A cell unit for a fuel cell, comprising:
an electrolyte membrane;
an electrode unit, comprising an anode being formed on one surface of the electrolyte membrane and a cathode being formed on the other surface of the electrolyte membrane;
a current collector, being stacked on the electrode unit to be electrically connected to the electrode unit; and
a conductive layer, being interposed between the electrode unit and the current collector to reduce a contact resistance between the electrode unit and the current collector.

2. The cell unit for a fuel cell of claim 1, wherein a plurality of electrode units are included, and
the current collector is a flexible printed circuit board which electrically connects the plurality of electrode units to each other.

3. The cell unit for a fuel cell of claim 2, wherein the current collector electrically connects the plurality of electrode units to each other in series.

4. A method for manufacturing a cell unit for a fuel cell in which a current collector is stacked on an electrode unit having an anode and a cathode, the method comprising:
forming the electrode unit on both surfaces of an electrolyte membrane;
forming a conductive layer on the electrode unit to reduce a contact resistance between the electrode unit and the current collector; and
stacking the current collector on the conductive layer to be electrically connected to the electrode unit.

5. The method of claim 4, wherein the forming the conductive layer is performed by applying a conductive material on the electrode unit by use of an inkjet method.

6. The method of claim 5, further comprising: curing and sintering the conductive layer, after the stacking the current collector.

7. The method of claim 6, further comprising: pressing the current collector, after the stacking the current collector.

8. The method of claim 7, wherein the curing and sintering the conductive layer and the pressing the current collector are simultaneously performed.

9. The method of claim 4, wherein a plurality of electrode units are included, and
the current collector is a flexible printed circuit board which electrically connects the plurality of electrode units to each other.

10. The method of claim 9, wherein the current collector electrically connects the plurality of electrode units to each other in series.
